(19) United States
(12) Patent Application Publication
(10) Pub. No.: US 2019/0011070 A1
(43) Pub. Date: Jan. 10, 2019

(54) DIVISIBLE VALVE CONNECTOR

(71) Applicant: Asetek Danmark A/S, Aalborg East (DK)

(72) Inventor: Lars Brinkmann Fuglsang, Aalborg (DK)

(73) Assignee: Asetek Danmark A/S, Aalborg East (DK)

(21) Appl. No.: 15/645,056

(22) Filed: Jul. 10, 2017

(51) Int. Cl. F16L 37/30; F16K 5/04; F16K 5/18; F16K 31/60; F16K 27/06; F16L 37/12; F16L 37/127

(52) U.S. Cl. CPC F16L 37/30; F16K 5/04; F16K 5/181; F16L 37/127; F16K 27/065; F16L 37/1205; F16K 31/60

(57) ABSTRACT

A divisible valve connector for connecting two fluid conduits is provided. The connector may have a first component defining a first fluid connection and a second component defining a second fluid connection. The first component may include a first valve body section and a first shaft section while the second component may include a second valve body section and a second shaft section. The first component and second component may be configured to releasably interlock together to form the valve connector and, when interlocked, the first shaft section and second shaft section form a unitary shaft rotatable between an opened position and a closed position.

### BACKGROUND

### Technical Field

The present disclosure relates generally to the field of fluid connectors and, more particularly, dripless fluid connectors for liquid cooling systems for cooling heat-generating components of a computer.

### Background Description

Most quick connect couplings have valve components that remain in the flow path after the coupling is connected and valves opened. As a result, the fluid must flow around these components, which act as restrictions resulting in turbulent flow that increases pressure drop and fluid temperature. In some systems this increase in pressure drop and fluid temperature is not a significant design concern. However, for some systems, such as liquid cooling systems for computers, where there can be significant design limitations (e.g., available space, temperature, energy), minimizing space, pump pressures, heat generation, and energy consumption can be important. Therefore, couplings that minimize space while maximizing flow with an unobstructed flow path are desired. Another important requirement of a quick connect coupling for a liquid cooling system for electronic is minimizing or preventing spillage of the cooling fluid upon disconnection. This is desired to avoid shorting electronic components or causing other damage.

Although there are quick connect coupling that are designed for or used with liquid cooling systems for computers, there exists a need for a quick connect coupling with an unobstructed flow path to minimize pressure drop and thereby improve system (and/or energy) efficiency and also to minimize or prevent fluid spillage upon disconnection and to provide compact, simple, and reliable operation.

### SUMMARY

The present disclosure is directed to a divisible valve connector that provides a compact connection mechanism for fluidly connecting fluid conduits with an open flow path in between that minimizes pressure drop while enabling dripless closing and disconnection.

In one aspect, the present disclosure is directed to a divisible valve connector. The connector may include a first component defining a first fluid connection, the first component comprising a first valve body section and a first shaft section. The connector may also include a second component defining a second fluid connection, the second component comprising a second valve body section and a second shaft section. The first component and second component may be configured to releasably interlock together to form the valve connector and, when interlocked, the first shaft section and second shaft section may form a unitary shaft rotatable between an opened position and a closed position. When the first shaft section and the second shaft section are in the opened position, the first fluid connection and the second fluid connection may be fluidly connected via a fluid passage through the first shaft section. When the first shaft section and the second shaft section are in the closed position, the first fluid connection may be sealed and the second fluid connection may be sealed. When the first shaft section and the second shaft section are in the closed position, the first component and the second component may be capable of being separated while the first fluid connection and the second fluid connection remain sealed.

In another aspect, the present disclosure is directed to a method of connecting a divisible fluid connector. The method may include joining a first component defining a first fluid connection with a second component defining a second fluid connection, wherein the first component includes a first valve body section and a first shaft section and the second component includes a second valve body section and a second shaft section. The method may also include rotating a unitary shaft from a closed position to an open position, wherein the unitary shaft is formed of the first shaft section and second shaft section when the first component and the second component are joined. When the first shaft section and the second shaft section are in the open position, the first fluid connection and the second fluid connection may be fluidly connected via a fluid passage through the first shaft section. When the first shaft section and the second shaft section are in the closed position, the first fluid connection and the second fluid connection may be sealed. When the first shaft section and the second shaft section are in the closed position, the first component and the second component may be capable of being separated while the first fluid connection and the second fluid connection remain sealed. When the first component and second component are separate the first shaft section and second shaft section may be locked in position.

In another aspect, the present disclosure is directed to a method of disconnecting a divisible fluid connection. The method may include separating a first component defining a first fluid connection from a second component defining a second fluid connection, wherein the first component includes a first valve body section and a first shaft section and the second component includes a second valve body section and a second shaft section. The method may also include rotating a unitary shaft from an open position to a closed position, wherein the unitary shaft is formed of the first shaft section and the second shaft section when the first component and the second component are joined. When the first shaft section and the second shaft section are in the open position, the first fluid connection and the second fluid connection may be fluidly connected via a fluid passage through the first shaft section. When the first shaft section and the second shaft section are in the closed position, the first fluid connection and the second fluid connection may be sealed. When the first shaft section and the second shaft section are in the closed position, the first component and the second component may be capable of being separated while the first fluid connection and the second fluid connection remain sealed. When the first component and second component are separate the first shaft section and second shaft section may be locked in position.

### BRIEF DESCRIPTION OF DRAWINGS

FIG. 1 is a perspective view of a divisible valve connector in the opened and connected position connecting two conduits, according to an exemplary embodiment.

FIG. 2 is a perspective view of the divisible valve connector of FIG. 1 in a closed and separated or divided position, according to an exemplary embodiment.

FIG. 3A is a cross-sectional view of the divisible valve connector of FIG. 1 in the opened and connected position.

FIG. 3B is a cross-sectional view of the divisible valve connector of FIG. 1 in the closed and connected position.

FIG. 4A is a perspective view of a first shaft section of the divisible valve connector of FIG. 1.

FIG. 4B is a perspective view of a second shaft section of the divisible valve connector of FIG. 1.

FIG. 4C is a perspective view of a unitary shaft of the divisible valve connector of FIG. 1 formed by the first shaft section and second shaft section of FIGS. 4A and 4B.

FIG. 5 is a side view of the divisible valve connector of FIG. 1.

FIGS. 6A and 6B are rear and front perspective views of the divisible valve connector of FIG. 1 with the conduits removed.

FIG. 7A is a partial cutout view of a portion of a divisible valve connector, according to an exemplary embodiment.

FIG. 7B is another partial cutout view of a portion of a divisible valve connector in the closed position, according to an exemplary embodiment.

FIG. 8 is a perspective cross-sectional view of a divisible valve connector where a first lock is unlocked and a shaft lock is locked, according to an exemplary embodiment.

FIG. 9 is a perspective cross-sectional view of a divisible valve connector where the first lock is locked and the shaft lock is unlocked, according to an exemplary embodiment.

FIG. 10 is a perspective view of a first gasket section and a second gasket section of the divisible valve connector of FIG. 1 in isolation.

FIG. 11 is a partial cutout view of a portion of the divisible valve connector of FIG. 1.

FIG. 12 is a review cross-sectional view of the divisible valve connector, according to an exemplary embodiment.

FIG. 13 is illustration showing some of the forces applied to a portion of a first gasket section and a second gasket section, according to an exemplary embodiment.

FIG. 14 is a perspective view showing the mating of a portion of a first gasket section and a second gasket section, according to an exemplary embodiment.

FIGS. 15A, 15B, 15C, and 15D illustrate a method of connecting the divisible valve connector of FIG. 1.

FIG. 16 is a perspective view identifying some dimensions of a divisible valve connector, according to an exemplary embodiment.

### DETAILED DESCRIPTION

Reference will now be made in detail to embodiments of the present disclosure, examples of which are illustrated in the accompanying drawings. Where possible, the same reference numbers will be used throughout the drawings to refer to the same or like parts.

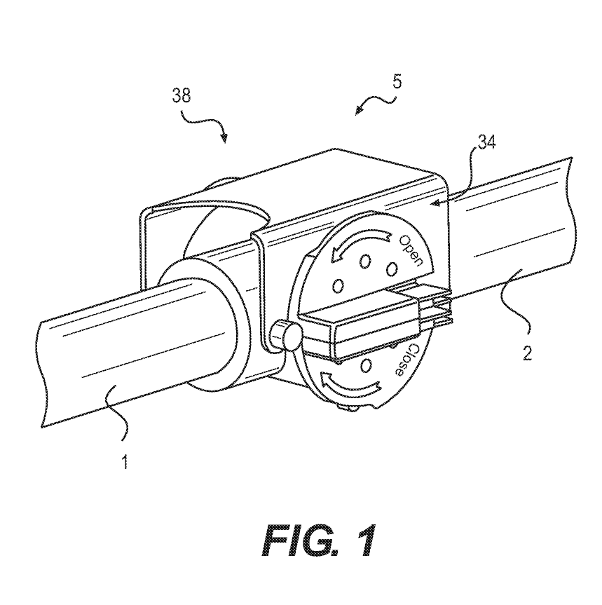

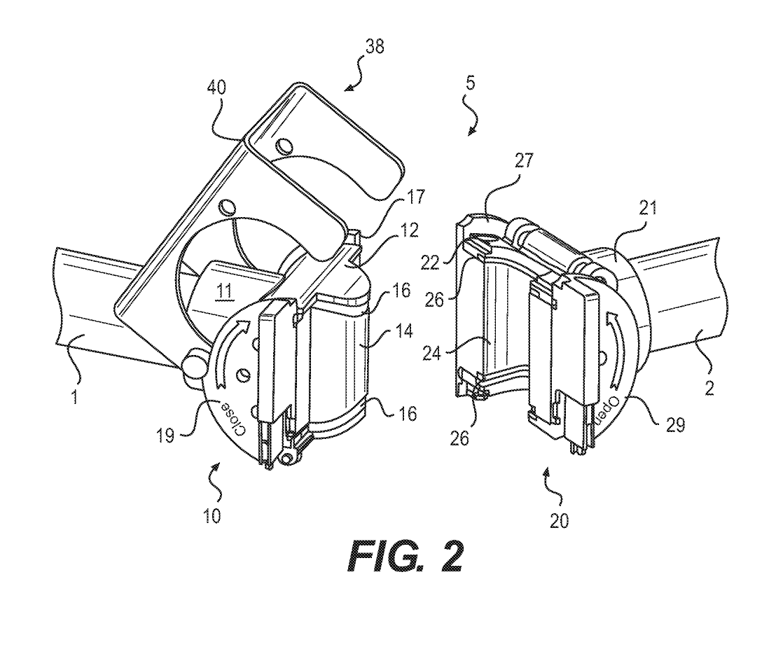

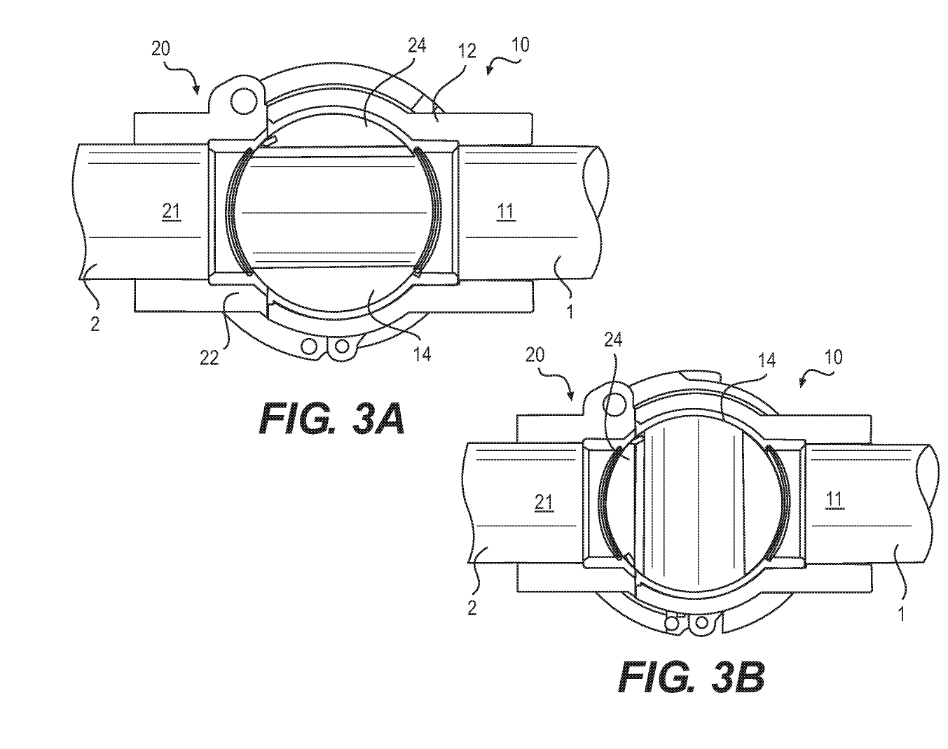

FIG. 1 shows an illustrative embodiment of a divisible valve connector 5 in an opened and connected arrangement while FIG. 2 shows divisible valve connector 5 in a closed and separated arrangement. FIG. 3A shows a cross-sectional view of connector 5 in the opened and connected arrangement while FIG. 3B shows a cross-sectional view of connector 5 in a closed and connected arrangement. As will be described herein, connector 5 provides a compact connection mechanism for fluidly connecting a first fluid conduit 1 and a second fluid conduit 2 with an open flow path in between that minimizes pressure drop while enabling dripless closing and disconnection.

As show in FIG. 2, Connector 5 includes a first component 10 that defines a first fluid connection 11 and a second component 20 that defines a second fluid connection 21. First component 10 may include a first valve body section 12 and a first shaft section 14 configured to rotate with first valve body section 12. Second component 20 may include a second valve body section 22 and a second shaft section 24 configured to rotate within second valve body section 22. First component 10 and second component 20 are configured such that they may be joined and interlocked thereby forming connector 5, as shown in FIG. 1.

When in the closed and separated arrangement as shown in FIG. 2, or in the closed and connected arrangement as shown in FIG. 3B, first shaft section 14 may be positioned relative to first valve body section 12 such that first fluid connection 11 is sealed. And first component 10 may be configured to prevent the rotation of first shaft section 14 relative to first valve body section 12 when first component 10 is closed and detached, thereby keeping first fluid connection sealed 11. Similarly, when in the closed position, as shown in FIGS. 2 and 3B, second shaft section 24 may be positioned relative to second valve body section 22 such that second fluid connection 21 is sealed. And second component 20 may be configured to prevent the rotation of second shaft section 24 relative to second valve body section 22 when second component 20 is closed and detached, thereby keeping second fluid connection sealed 21.

FIG. 2 shows a perspective view of first component 10 and second component 20 in a closed and separated arrangement. As illustrated in FIG. 2, first shaft section 14 may be positioned within and partially surrounded by first valve body section 12. First component 10 may also have a first gasket section 16 positioned between first valve body section 12 and first shaft section 14. Also as illustrated in FIG. 2, second shaft section 24 may be positioned within and partially surrounded by second valve body section 22. Second component 20 may also have a second gasket section 26 positioned between second valve body section 22 and second shaft section 24.

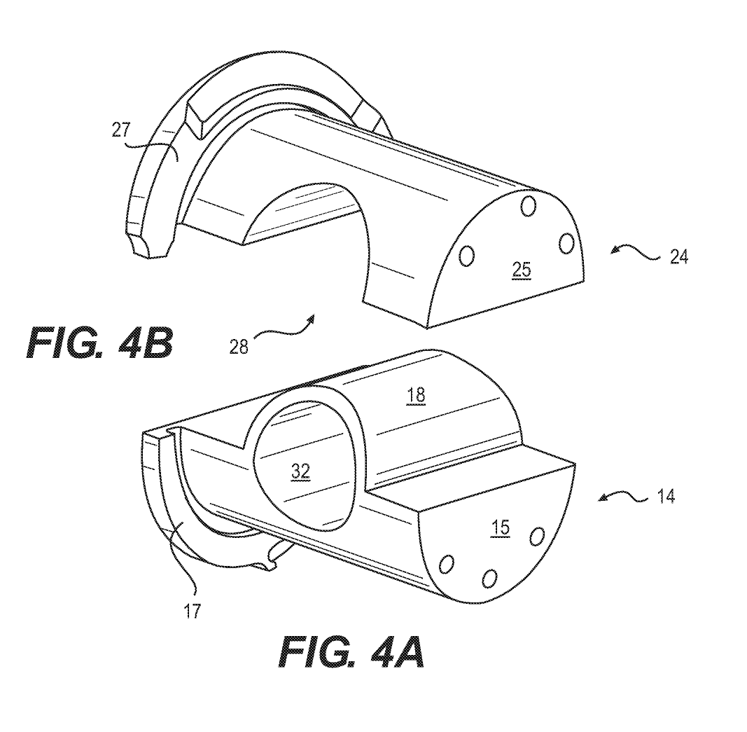

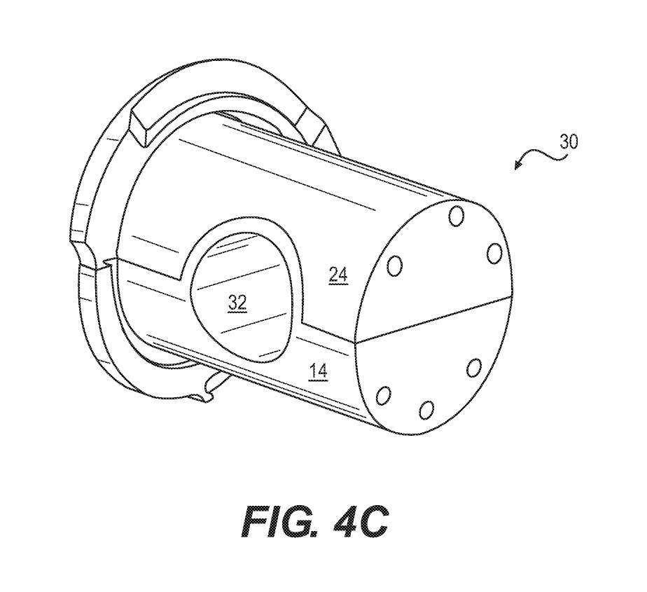

FIGS. 4A and 4B show illustrative embodiments of first shaft section 14 and second shaft section 24 in isolation. First shaft section 14 may be formed of a generally semi-cylindrical shaped section 15 having a semi-disc shaped section 17 extending radially from one end. Similarly, second shaft section 24 may be formed of a generally semi-cylindrical shaped section 25 having a semi-disc shaped section 27 extending radially from one end. First shaft section 14 and second shaft section 24 may have complimentary shapes that enable them to fit together in order to form a unitary shaft 30, as shown in FIG. 4C. For example, as shown in FIGS. 4A and 4B, first shaft section 14 can have an arc section 18 protruding from the semi-cylindrical shaped section 15 while second shaft section 24 can have an arc shaped recess section 28 in the semi-cylindrical shaped section 25. Arc section 18 may be configured to fit within arc shaped recess section 28 when first shaft section 14 and second shaft section 24 are joined to form unitary shaft section 30. When joined, unitary shaft 30 may form a generally cylindrical shaft with a disc 31 extending radially from one end, as shown in FIG. 4C. It is contemplated that unitary shaft 30 may take the form of other suitable shapes. For example, in some embodiments, unitary shaft may be ball or globe shaped.

As shown in FIGS. 4A and 4C, first shaft section 14 may define a fluid passage 32 that extends through arc section 18 and a portion of the semi-cylindrical body section. Fluid passage 32 may have a circular cross-sectional flow path as shown in FIGS. 4A and 4C or any other suitable shape. For example, in some embodiments, fluid passage 32 may be square, rectangular, oval, triangular, or other similar shape. The shape of fluid passage 32 may be designed to correspond to the shape of first and second fluid conduits 1, 2 being connected by connector 5. For example, if first and second fluid conduits 1, 2 have circular cross-sectional flow paths then an embodiment of connector 5 may be selected having a corresponding circular cross-sectional flow path.

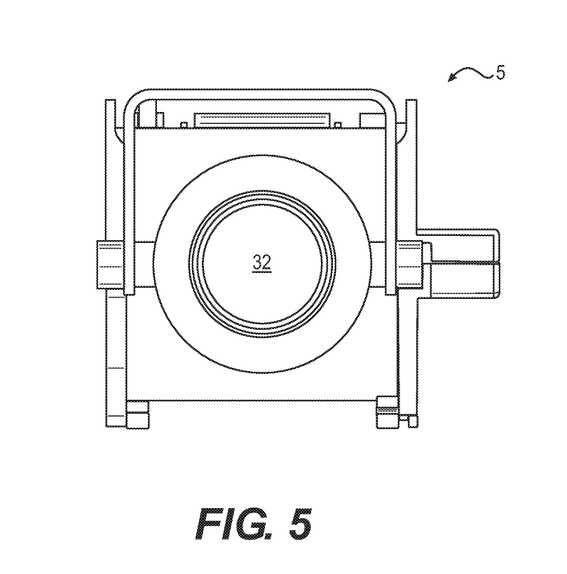

A cross-sectional area of fluid passage 32 may also vary along with the overall dimensions of connector 5. For example, for a fluid passage 32 having a circular cross-sectional area, as shown in FIGS. 4A and 4C, the diameter may be, for example, less than 0.25 inches, about 0.25 inches, about 0.375 inches, about 0.5 inches, about 0.625 inches, about 0.75 inches, about 0.875 inches, about 1 inch, about 1.25 inches, about 1.5 inches, about 1.75 inches, about 2 inches, or greater than about 2 inches. The cross-sectional area and/or the diameter of circular fluid passage 32, may be configured or selected to correspond to the cross-sectional area of the flow path of first and second fluid conduits 1, 2 being connected by connector 5. For example, an embodiment of connector 5 having a fluid passage 32 with a 1-inch diameter may be selected when conduits 1, 2 being connected by connector 5 each also have about a 1-inch diameter. As a result, connector 5 may provide a straight unobstructed flow through connection, thereby minimizing pressure drop. For example, FIG. 5 shows a side view of connector 5 looking down through fluid passage 32. As illustrated by FIG. 5, the diameter of fluid passage 32 may correspond to a diameter of first fluid connection 11 and second fluid connection 21, which may correspond with conduits 1, 2, thereby minimizing any fluid flow restriction through connector 5.

In some embodiments, fluid passage 32 may be configured to have a diameter less than or greater than first fluid connection 11 and second fluid connection 21. For example, if it is desired to have a pressure drop across connector 5, a connector 5 having a fluid passage 32 with a smaller diameter than first fluid connection 11 and second fluid connection 21 may be selected. In some embodiments, fluid passage 32 may be configured to have a cross-sectional diameter that increases or decreases across first shaft section 14. For example, in some embodiments fluid passage 32 could be shaped like a reducer (e.g., concentric or eccentric). For such embodiments, connector 5 could be used to connect conduits of different diameters. For example, fluid passage 32 could have a diameter of 1 inch at one end and a diameter of 0.75 inch at the other end thereby increasing or decreasing the fluid flow path through fluid passage 32 depending on the direction of flow. For such embodiments, first fluid connection 11 defined by first component 10 and second fluid connection 21 defined by second component 20 may be configured to have flow paths equal to the size of the corresponding end of fluid passage 32. For example, first fluid connection 11 may have a 1-inch flow path diameter while second fluid connection 21 may have a 0.75-inch flow path diameter.

It is contemplated that for some embodiments, the features of first shaft section 14 and second shaft section 24, as described herein, may be switch such that fluid passage 32 may be defined by second shaft section 24.

Referring back to FIG. 2, first component 10 may include a semi-circular shaped first handle section 19 coupled to first shaft section 14 at the end opposite semi-disc shaped section 17. Second component 20 may include a semi-circular shaped second handle section 29 coupled to second shaft section 24 at the end opposite semi-disc shaped section 27. When first component 10 and second component 20 are joined, as shown in FIG. 1, first handle section 19 and second handle section 29 may join to form a unitary handle 34. In some embodiments, handle 34 may be circular disc shaped with a rectangular shaped grasping section that extends from and bisects the circular disc. The gasping section may be configured to facilitate easy rotate of handle 34 by an operator of connector 5. It is contemplated that for other embodiments, handle 34 may be any other suitable shape. As shown in FIG. 2, in some embodiments, handle 34 may include identification markings for indicating the direction of rotation for opening and closing of connector 5. It is contemplated that for some embodiments, connector 5 (e.g., shaft 30) may be connected to an actuator configured for automatic and/or remote operation. For such embodiments, handle 34 may be eliminated.

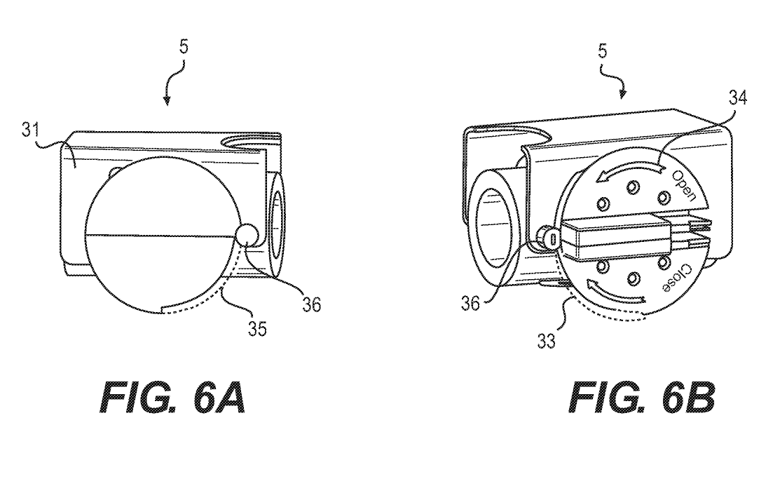

Handle 34 may be configured to enable rotation of shaft 30 within first valve body section 12 and second valve body section 22, when first component 10 and second component 20 are joined, for example, as illustrated in FIG. 1. In some embodiments, connector 5 may include a rotation limiting means for limiting the rotation of handle 34 and shaft 30 between the opened and closed positions. For example, FIGS. 6A and 6B show the front and back side of connector 5, which includes a stop 36 positioned adjacent handle 34 on the front side and on the back side a stop 36 positioned adjacent disc 31. Stops 36 may be configured to limit the rotation of handle 34 and shaft 30 to about 90 degrees between the opened and the closed position. To limit rotation handle 34 may have an inset portion 33 that extends along about a quarter of the outer circumference of handle 34 and disc 31 may have an inset portion 35 that extends along about a quarter of the outer circumference of disc 31. At least a portion of stops 36 may be positioned in the space made available by the inset portions 33, 35, such that when handle 34 and shaft 30 is rotated, stops 36 limit rotation of handle 34 and shaft 30 by contact with the end of each inset portion 33, 35. It is contemplated that in some embodiments a single stop 36 may be used in conjunction with either handle 34 or shaft 30.

Connector 5 may also include one or more locks configured to prevent unintended opening or disconnection of first component 10 and/or second component 20. For example, connector 5 may include a first lock 38 configured to prevent unintended disconnection. As shown in FIG. 1, first lock 38 may be configured to surround at least a portion of first component 10 and second component 20, when joined together, thereby locking first component 10 and second component 20 together. As shown in FIG. 2, first lock 38 may include a c-shaped channel member 40 with semi-circular cutouts through each side wall, such that channel member 40 may be configured for positioning around a portion of first component 10 and second component 20 and the cutouts may be configured to surround a portion of first valve body section 12, second valve body section 22, first shaft section 14, and second shaft section 24. When channel member 40 is positioned around first component 10 and second component 20, the cutouts can prevent separation of first component 10 and second component 20, thereby preventing separation of first valve body section 12, second valve body section 22, first shaft section 14, and second shaft section 24. First lock 38 may be configured to attach to either first component 10 and/or second component 20. For example, as shown in FIG. 2, channel member 40 of first lock 38 may be rotatable attached to first component 10, enabling channel member 40 to rotate between an unlocked position, as shown in FIG. 2 and a locked position, as shown in FIG. 1.

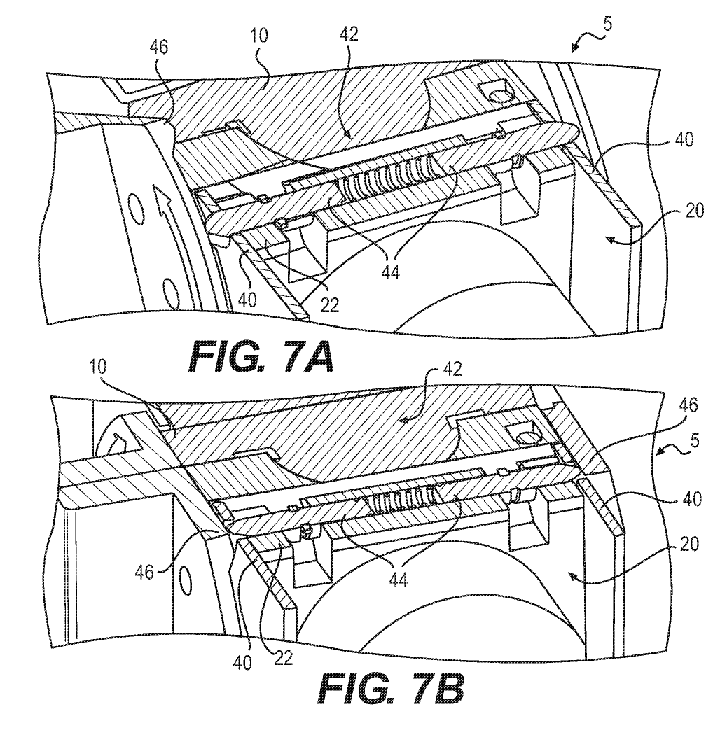

Connector 5 may include additional locks, which may be designed to prevent unintended opening or disconnection of first component 10 and second component 20. The additional locks as will be described herein may be designed to work in conjunction with or independently of first lock 38. In some embodiments, as shown in FIGS. 7A and 7B, connector 5 may include a second lock 42, which may be housed in second component 20. In other embodiments, second lock 42 may be housed in first component 10. Second lock 42 may comprise a locking pin 44 that is configured to extend from first component 10 or second component 20 and pass through and engage with channel member 40 when channel member 40 is in the locked position. FIG. 7A shows a partial cutout of connector 5 in which second lock 42 is in a locked position (e.g., locking pin 44 protrudes from both sides of second component 20 and passes through holes in the side walls of channel member 40. As a result, when second lock 42 is in the locked position, channel member 40 and first lock 38 is prevented from rotating thereby prevent it from unlocking (i.e., transition from the locked to unlocked position). As shown in FIGS. 7A and 7B, locking pin 44 may be configured to be a double-sided spring loaded locking pin that extends from both sides of second component 20 and engages both side walls of channel member 40. In other embodiments, locking pin 44 may be actuated by other mechanical means (e.g., hydraulically) besides a spring or in some embodiments, locking pin may be magnetically actuated. It is contemplated that in other embodiments, a single side locking pin may be utilized that is configured engage just one side or the other of channel member 40. It is also contemplated that any suitable actuating means for locking pin 44 may be used. It is also contemplated that in other embodiments, one or more additional locking pins may be incorporated into connector 5. For example, a first locking pin may be housed in first component 10 and a second locking pin may be housed in second component 20, and each locking pin may be configured to engage with a hole of channel member 40.

Second lock 42 may be unlocked by partially depressing locking pin 44 back into second component 20. This may be carried out by handle 34 in combination with disc 31 of shaft 30 when handle 34 and shaft 30 are rotated from the opened position to the closed position. For example, as shown in FIG. 7B, handle 34 and disc 31 may have spacers 46 that extends inward toward locking pin 44 and becomes aligned with locking pin 44 when handle 34 and disc 31 are rotated to the closed position. Spacers 46 may force locking pin 44 to partially recede with second valve body section 22. The outer ends of locking pin 44 may be tapered, thereby when channel member 40 is rotated open, unlocking first lock 38, the side walls of channel member 40 may contact the tapered sections forcing locking pin 44 to recede further into second valve body section 22 enabling channel member 40 the clearance needed pass by locking pin 44.

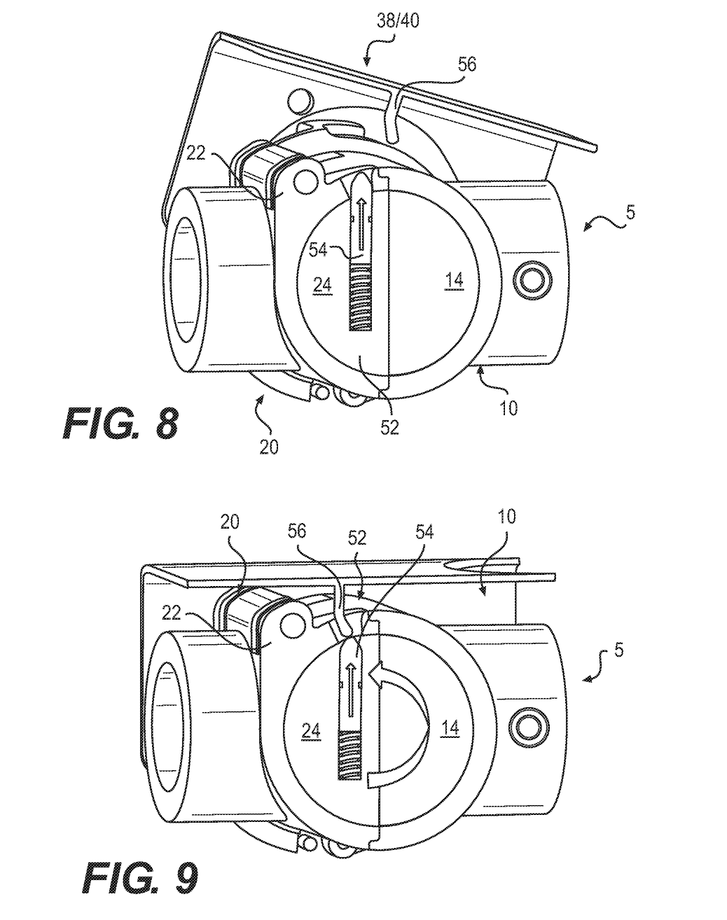

Some embodiments of connector 5 may include additional locks designed to prevent unintended rotation of first shaft section 14, second shaft section 24, or unitary shaft 30 when first component 10 and second component 20 are not joined and locked together. For example, connector 5 may include one or more shaft locks configured to prevent rotation of first shaft section 14 and/or second shaft section 24. For example, as shown in FIGS. 8 and 9, connector 5 may include a shaft lock 52 that comprises a shaft pin 54, which may be positioned in a hollow cylinder within second shaft section 24. Shaft pin 54 may be mechanically loaded (e.g., spring loaded) and biased such that it moves away from second shaft section 24 and extends into an aligned opening in second valve body section 22, as shown in FIG. 8. When first lock 38/channel member 40 is in an unlocked position, as shown in FIG. 8, shaft lock 52 may be in a locked positioned. For example, when shaft lock 52 is in a locked position shaft pin 54 can extend out of second shaft section 24 and into the aligned opening in second valve body section 22, thereby preventing rotation of second shaft section 24. Shaft lock 52 may work in conjunction with first lock 38, such that when first lock 38 is engaged and locked shaft lock 52 unlocks. Shaft lock 52 may be unlocked by pressing of shaft pin 54 so that it partially recedes back through the opening in second valve body section 22. As shown in FIG. 9, channel member 40 may be configured to include an extension member 56 designed to align with and press shaft pin 54 into the unlocked position when channel member 40 is engaged. As shown in FIGS. 8 and 9, shaft pin 54 may have a tapered end which enables second valve body section 22 to further depress shaft pin 54 into second shaft section 24 when rotated.

Although, not shown in FIGS. 8 and 9, connector 5 may be configured to include shaft locks 52, as described herein, positioned in both first shaft section 14 and second shaft section 24, thereby enabling separate locking of each shaft section and prevention of unintended opening of first fluid connection 11 and second fluid connection 21. It is envisioned that the shaft lock for first shaft section 14 may be configured just like shaft lock 52 for second shaft section 24. For embodiments of connector 5 having multiple shaft locks 52, channel member 40 may have an appropriate number of extension members 56 configured to align with and press to unlock the shaft locks 52.

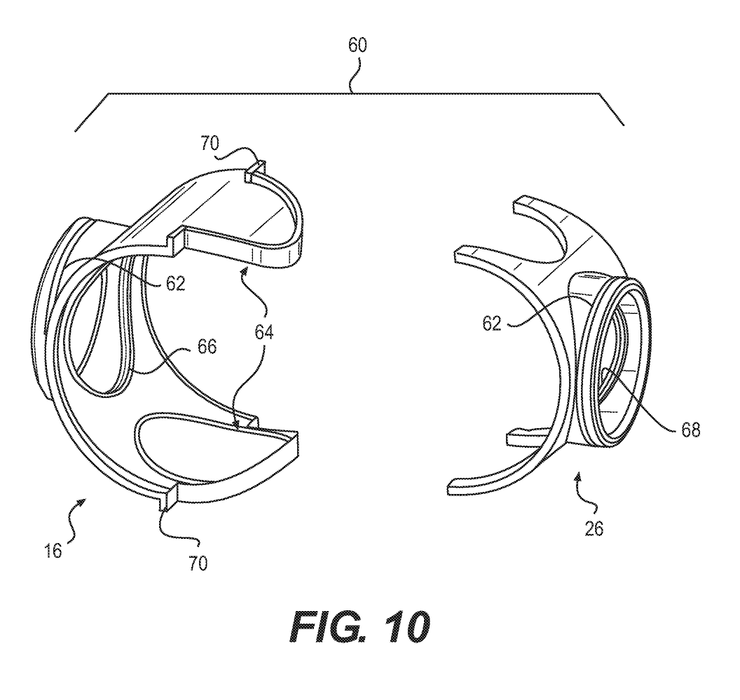

Referring back to FIG. 2, connector 5 may include first gasket section 16 and second gasket section 26. FIG. 10 is a perspective view of first gasket section 16 and second gasket section 26. As described herein, first gasket section 16 may be configured to seal first fluid connection 11 when first component 10 is in the closed position whether first component 10 is connected or disconnected to second component 20. Second gasket section 26 may be configured to seal second fluid connection 21 when second component 20 is in the closed position whether second component is connected or disconnected to first component 10. First gasket section 16 and second gasket section 26 are configured to align and interlock when first component 10 and second component 20 are joined. First gasket section 16 and second gasket section 26 when interlocked may form a unitary gasket 60 configured to seal the fluid interfaces between first fluid connection 11 and fluid passage 32 and fluid passage 32 and second fluid connection 21. First gasket section 16 and second gasket section 26 may be made of any suitable polymer material, for example, ethylene propylene diene monomer (EPDM), nitrile butadiene rubber (NRB), VITON, polyether ether keton (PEEK), or polytetrafluoroethylene (PTFE).

First gasket section 16 and second gasket section 26 may each include a plurality of embedded o-rings that partially protrude from the surfaces of the gasket, as illustrated in FIG. 10. For example, first and second gasket sections 16, 26 may each include at least one outer o-ring 62 on the outer surface configured to seal the interface between first or second valve body section 12, 22 and the corresponding gasket. First gasket section 16 and second gasket section 26 may both include a plurality of embedded o-rings protruding from the interior surfaces configured to create a double seal of shaft 30 both when in the open position and closed position. For example, as shown in FIG. 10, first gasket section 16 may include a set of o-rings 64 positioned opposite one another configured to seal the ends of fluid passage 32 when in the closed position. First gasket section 16 may also include a circular o-ring 66 configured to seal one end of fluid passage 32 when in the opened position while second gasket section 26 includes a circular o-ring 68 position opposite o-ring 66 configured to seal the opposite end of fluid passage 32 when in the opened position.

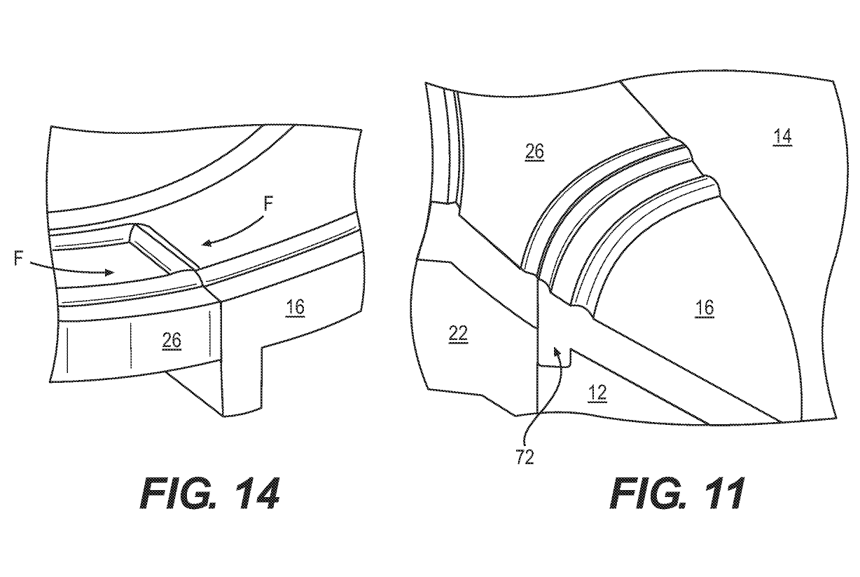

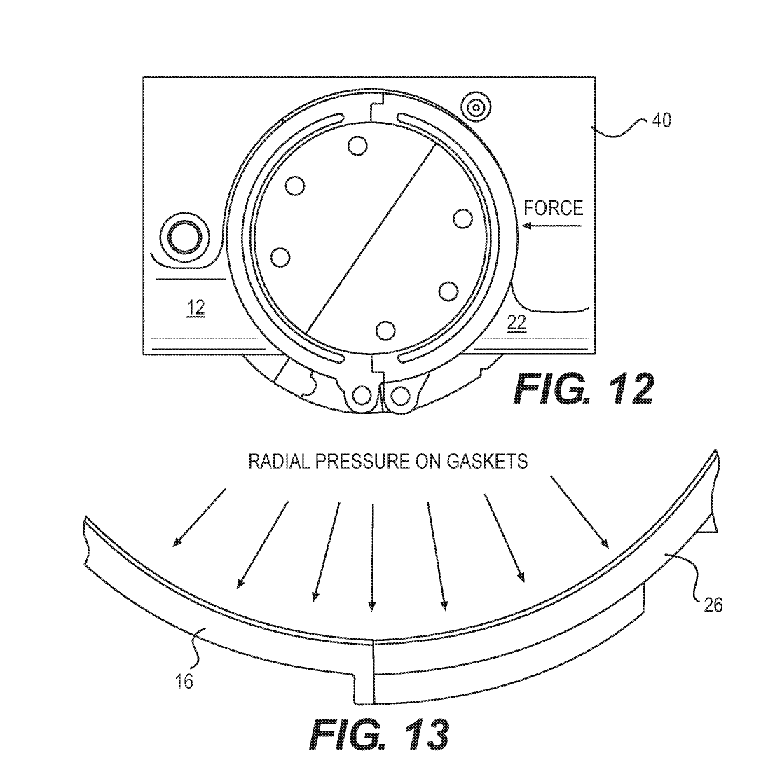

As shown in FIG. 10, first gasket section 16 may include a lip 70 that extends along a perimeter of the upper and lower edge that interfaces with second gasket section 26. FIG. 11 shows a partial cut away view of connector 5, illustrating how, first valve body section 12 may include a channel 72 configured to receive lip 70 positioning it adjacent to second valve body section 22. Lip 70 positioned in channel 72 between first and second valve body sections 12, 22 may be pre-compressed and sealed when first lock is engaged. For example, as shown in FIG. 12 when first lock is engaged, it will apply a force bringing first valve body section 12 and second valve body section 22 together, which will translate to a compression force on first gasket section 16 and second gasket section 26. This compressive force may translate to radial pressure on first and second gasket sections 16, 26 as illustrated in FIG. 13 and gasket to gasket compression of first and second gasket sections 16, 26, as illustrated in FIG. 14.

First gasket section 16 and second gasket section 26 may be configured to enabling sealing of first fluid connection 11 and second fluid connection 21, as well as sealing of fluid passage 32 in the closed position such that any fluid located in fluid passage 32 when closed may be sealed and held in fluid passage 32 until opened again.

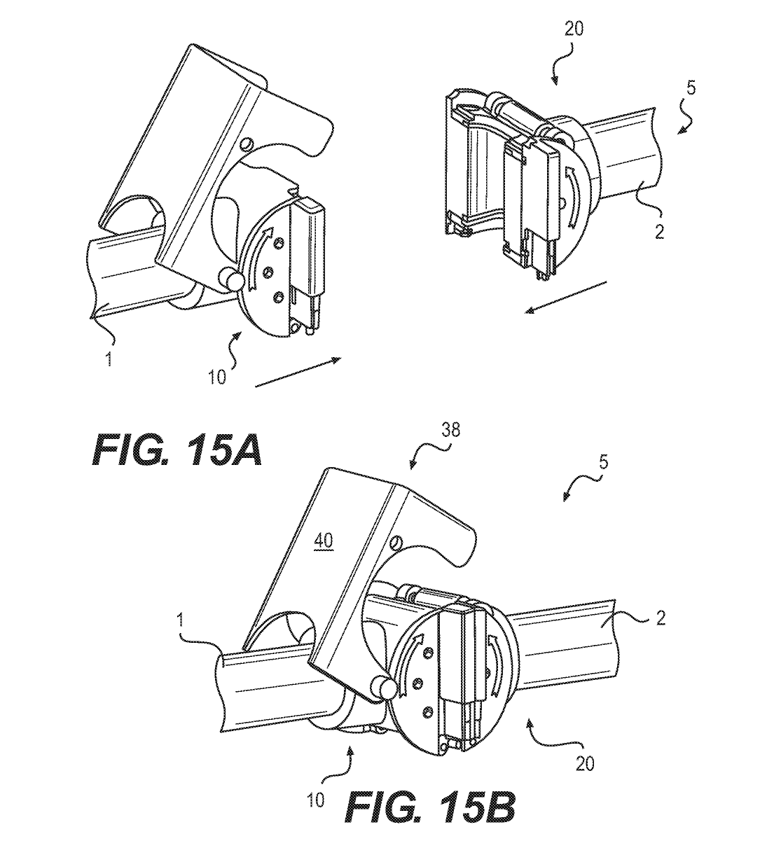

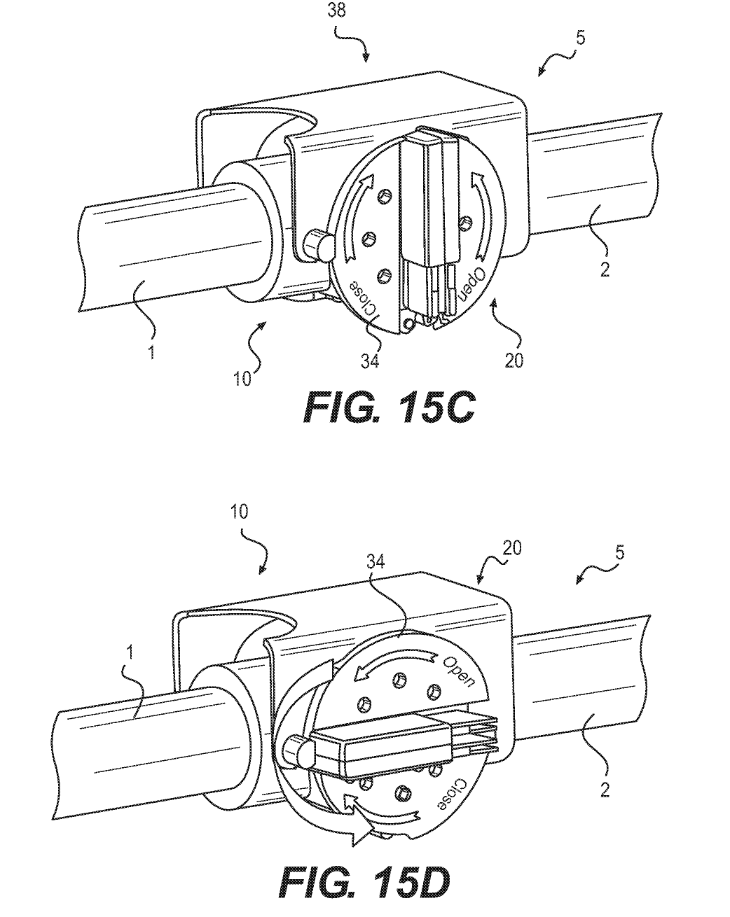

FIGS. 15A-15D illustrate a method for transitioning connector 5 from a closed and separated position to a joined and opened position by connecting first component 10 and second component 20 and fluidly connecting first and second conduits 1, 2 via first fluid connection 11 and second fluid connection 21. As shown in FIG. 15A, the method may begin with first component 10 and second component 20 separated and each in the closed positions such that first fluid connection 11 and second fluid connection 21 are both sealed. As shown in FIG. 15A, first component 10 and second component 20 may be aligned and joined together enabling first valve body section 12, first shaft section 14, and first handle section 19 to be interlocked, as shown in FIG. 15B, with their counterpart second valve body section 22, second shaft section 24, and second handle section 29 of second component 20.

Once first component 10 and second component 20 are interlocked, as shown in FIG. 15B, first lock 38 may be engaged by rotating channel member 40 around first component 10 and second component 20. FIG. 15C shows connector 5 with first lock 38 in the locked position. For embodiments that include one or more shaft locks 52, engaging of first lock 38 will result in the unlocking of shaft lock(s) 52. Next, handle 34 may be rotated thereby rotating unitary shaft 30 and transiting connector 5 from the closed position to the opened position. By rotating handle 34 and unitary shaft 30, fluid passage 32 becomes aligned with conduits 1, 2. FIG. 15D shows connector 5 in the opened position. For embodiments that include a second lock 42, rotating handle 34 from the closed position will cause second lock to engage, thereby preventing unlocking of first lock 38. As shown in FIG. 15D, the rectangular grip section of handle 34 may be configured to alignment with the direction of fluid flow in fluid passage 32.

A method for transitioning connector 5 from a connected and opened position to a closed and separated position may include the steps described above except in reverse. For example, handle 34 may be rotated from the opened position to the closed position. For embodiments that include a second lock 42, rotating handle 34 from the opened position to the closed position will cause second lock 42 to disengage, thereby enabling the subsequent unlocking of first lock 38. Once handle 34 and unitary shaft 30 are in the closed position, first lock 38 may be unlocked by rotating channel member 40 away from second component 20. For embodiments that include one or more shaft locks 52, rotating channel member 40 away from second component 20 will cause shaft locks to engage thereby prevent rotation of first shaft section 14 and/or second shaft section 24. Once first lock 38 is unlocked, first component 10 and second component 20 may be divided without release of any fluid from first fluid connection 11, second fluid connection 21, and from within fluid passage 32.

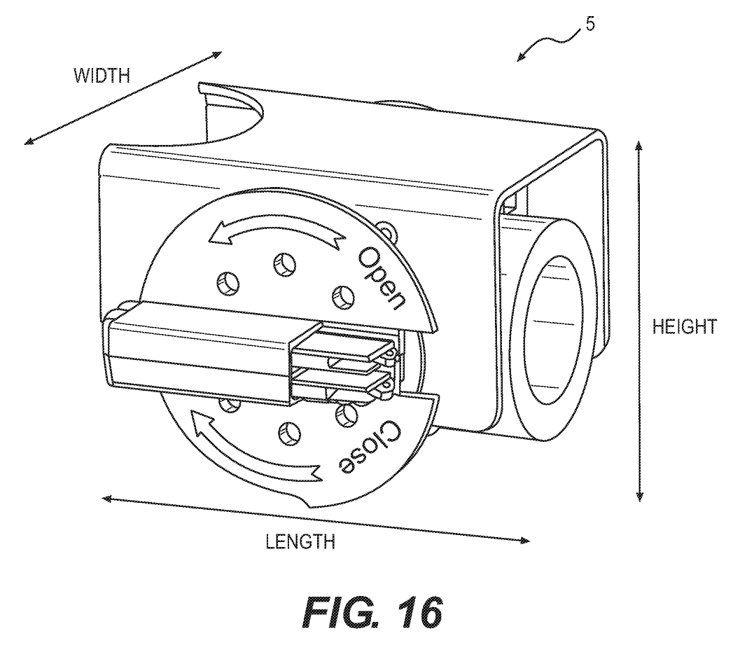

As described herein, connector 5 provides a connection mechanism for fluidly connecting fluid conduits 1, 2 with an open flow path that minimizes pressure drop while enabling dripless closing and disconnection. Connector 5 is able to provide this functionality in a compact design that occupies minimal volume compared to other quick-connect fittings. As shown in FIG. 16, connector 5 may have a length, a height, and a width that define the envelop dimensions for connector 5. For example, connector 5 having a flow path diameter of 1 inch may have a width of about 2.8 inches, a height of about 2.4 inches, and a length of about 3.1 inches. Thus, the total volume may be about 20.8 cubic inches. The ratio of flow path diameter to width can be about 1:2.8 or less, the ratio of flow path diameter to height can be about 1:2.4 or less, the ratio of flow path diameter to length can be about 1:3.1 or less, the ratio of flow path diameter to volume can be about 1:20.8 or less. The compact size of connector 5 may be particularly advantageous for certain applications where space may be very limited. For example, available space for liquid cooling systems installations in computers is often very limited so the ability to provide a compact, dripless, open flow path connector will be beneficial. This will enable reduced pressure drop, improved cooling system energy efficiency while minimizing or preventing fluid spillage.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the connector embodiments described herein although presented in the context of liquid cooling systems for computers, these connectors may be adapted for use in any fluid handling systems. Further, the connector embodiments described herein although described in the context of connecting to conduits, it is understood that connectors of the present disclosure may be used to connect a variety of structures for transporting fluid, including for example, pipes, tubes, headers, etc.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The term “about” or “approximately” as used herein means within an acceptable error range for the particular value as determined by one of ordinary skill in the art, which will depend in part on how the value is measured or determined, e. g., the limitations of the measurements system. For example, “about” can mean within one or more than one standard deviation per the practice in the art. Alternatively, “about” can mean a range of up to 20%, such as up to 10%, up to 5%, and up to 1% of a given value.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

1. A divisible valve connector, comprising:
a first component defining a first fluid connection, the first component comprising a first valve body section and a first shaft section; and
a second component defining a second fluid connection, the second component comprising a second valve body section and a second shaft section;
wherein the first component and second component are configured to releasably interlock together to form the valve connector and, when interlocked, the first shaft section and second shaft section form a unitary shaft rotatable between an opened position and a closed position;
wherein, when the first shaft section and the second shaft section are in the opened position, the first fluid connection and the second fluid connection are fluidly connected via a fluid passage through the first shaft section;
wherein, when the first shaft section and the second shaft section are in the closed position, the first fluid connection is sealed and the second fluid connection is sealed; and
wherein, when the first shaft section and the second shaft section are in the closed position, the first component and the second component are capable of being separated while the first fluid connection and the second fluid connection remain sealed.

2. The divisible valve connector of claim 1, further comprising:
a first gasket section positioned between the first valve body section and the first shaft section; and
a second gasket section positioned between the second valve body section and the second shaft section.

3. The divisible valve connector of claim 2, wherein the first gasket section and second gasket section each include a plurality of embedded o-rings that protrude from the surfaces.

4. The divisible valve connector of claim 2, wherein the first gasket section has a lip that extends along a perimeter of an upper and a lower edge of the first gasket section that interfaces with the second gasket section.

5. The divisible valve connector of claim 1, further comprising:
a first handle section coupled to the first shaft section; and
a second handle section coupled to the second shaft section,
wherein the first handle section and the second handle section form a unitary handle when the first component and second component are coupled and the unitary handle is configured to rotate the unitary shaft when the handle is turned.

6. The divisible valve connector of claim 1, further comprising a stop positioned adjacent the handle or unitary shaft, wherein the stop is configured to limit the rotation of the handle or unitary shaft between the opened position and the closed position.

7. The divisible valve connector of claim 1, further comprising:
a first lock comprising a channel member that is configured to rotate around a portion of the first component and the second component locking them together, when the first and second components are interlocked together, and
wherein the channel member is rotationally attached to either the first component or the second component.

8. The divisible valve connector of claim 7, further comprising:
a second lock comprising a locking pin housed in either the first component or the second component that engages with the rotatable channel member of the first lock,
wherein, when the unitary shaft is in the closed position, the locking pin is in an unlocked position enabling the channel member of the first lock to rotate from a locked to an unlocked position.

9. The divisible valve connector of claim 7, further comprising a shaft lock comprising a shaft pin positioned within the second shaft section, wherein the shaft pin is configured to lock rotation of the second shaft section when the channel member is in an unlocked position and unlock rotation of the second shaft section when the channel member is in a locked position.

10. The divisible valve connector of claim 1, wherein the unitary shaft forms a cylindrical-shaped shaft.

11. The divisible valve connector of claim 1, wherein, when the first shaft section and the second shaft section are in the closed position, the first component and the second component are capable of being separated while the fluid passage remains sealed.

12. The divisible valve connector of claim 1, wherein a ratio of a flow path diameter of the divisible valve connector to a length of the divisible valve connector is about 1:3.1 or less.

13. A method of connecting a divisible fluid connector, the method comprising:
joining a first component defining a first fluid connection with a second component defining a second fluid connection, wherein the first component includes a first valve body section and a first shaft section and the second component includes a second valve body section and a second shaft section; and
rotating a unitary shaft from a closed position to an open position, wherein the unitary shaft is formed of the first shaft section and second shaft section when the first component and the second component are joined,
wherein when the first shaft section and the second shaft section are in the open position, the first fluid connection and the second fluid connection are fluidly connected via a fluid passage through the first shaft section;
wherein when the first shaft section and the second shaft section are in the closed position, the first fluid connection is sealed and the second fluid connection is sealed; and
wherein when the first shaft section and the second shaft section are in the closed position, the first component and the second component are capable of being separated while the first fluid connection and the second fluid connection remain sealed.

14. The method of claim 13, further comprising forming a handle from a first handle section coupled to the first shaft section and a second handle section coupled to the second shaft section, wherein the handle is formed when the first component and the second component are joined, and the handle is configured to rotate the unitary shaft when the handle is turned.

15. The method of claim 14, further comprising limiting the rotation of the handle or unitary shaft between the open position and the closed position by a stop positioned adjacent to the handle or unitary shaft.

16. The method of claim 13, further comprising locking the first component and the second component together using a first lock comprising a channel member that is configured to rotate around a portion of the first component and the second component when joined between a locked and unlocked position.

17. The method of claim 16, wherein
the first component further includes a first gasket section positioned between the first valve body section and the first shaft section and the second component further includes a second gasket section positioned between the second valve body section and the second shaft section; and
the first lock is configured such that when locked, the first valve body section and the second valve body section are pressed together applying pressure to the first gasket section and the second gasket section in an axial direction.

18. The method of claim 16, further comprising locking the first lock in the locked position place using a second lock comprising a locking pin housed in either the first component or the second component that engages with the channel member of the first lock thereby preventing rotation,
wherein the locking pin is configured such that, when the unitary shaft is in the closed position, the locking pin is in an unlocked position enabling the channel member of the first lock to rotate to the unlocked position.

19. The divisible valve connector of claim 16, further comprising locking rotation of the second shaft section when the channel member is in the unlocked position using a shaft lock comprising a shaft pin positioned within the second shaft section configured to engage with the second valve body.

20. A method of disconnecting a divisible fluid connection, the method comprising:
separating a first component defining a first fluid connection from a second component defining a second fluid connection, wherein the first component includes a first valve body section and a first shaft section and the second component includes a second valve body section and a second shaft section; and
rotating a unitary shaft from an open position to a closed position, wherein the unitary shaft is formed of the first shaft section and the second shaft section when the first component and the second component are joined,
wherein when the first shaft section and the second shaft section are in the open position, the first fluid connection and the second fluid connection are fluidly connected via a fluid passage through the first shaft section;
wherein when the first shaft section and the second shaft section are in the closed position, the first fluid connection is sealed and the second fluid connection is sealed; and
wherein when the first shaft section and the second shaft section are in the closed position, the first component and the second component are capable of being separated while the first fluid connection and the second fluid connection remain sealed.
